(19) United States
(12) Patent Application Publication
(10) Pub. No.: US 2007/0171830 A1
(43) Pub. Date: Jul. 26, 2007

(54) Apparatus, method and computer program product providing radio network controller internal dynamic HSDPA flow control using one of fixed or calculated scaling factors

(75) Inventors: Csaba Vulkan, Budapest (HU); Laszlo Korossy, Budapest (HU); Kari Veijalainen, Vantaa (FI); Lajos Bajzik, Budapest (HU)

Correspondence Address: HARRINGTON & SMITH, PC, 4 RESEARCH DRIVE, SHELTON, CT, 06484-6212, US

(73) Assignee: Nokia Corporation

(21) Appl. No.: 11/698,453

(22) Filed: Jan. 26, 2007

Related U.S. Application Data
(60) Provisional application No. 60/763,113, filed on Jan. 26, 2006.

(51) Int. Cl. H04J 1/16

(52) U.S. Cl. 370/235

(57) ABSTRACT

Flow statistics for a buffer that receives data from a plurality of other entities are collected, and an available bandwidth for an interface coupled to an output side of the buffer is determined. From those is determined an arrival rate such that the buffer would not be overloaded. A flow control message is sent to each of the entities that limits aggregate flow from the entities so as not to exceed the arrival rate. One embodiment uses a scaling factor in the flow control messages, the same scaling factor for each entity on any given scheduling interval. An entity receives the flow control message and from it determines an allowed amount CR_{allowed} of packet data units PDUs for that scheduling interval. The lower of CR_{allowed} and an allocation of granted credits CR is used to compute a send rate, which the entity uses as its maximum rate for the interval.

### CROSS REFERENCE TO RELATED APPLICATION

This application claims priority to U.S. Provisional Patent Application Ser. No. 60/763,113, filed on Jan. 26, 2006, which is hereby incorporated by reference.

### TECHNICAL FIELD

The exemplary and non-limiting embodiments of this invention relate generally to wireless communication systems and devices and, more specifically, relate to high speed downlink packet access (HSDPA) and related techniques. The exemplary and non-limiting embodiments of this invention relate further to a RNC (Radio Network Controller) internal architecture, as well as to features embodied in the RNC to provide HSDPA service to user equipment (UE).

### BACKGROUND

The HSDPA provides a packet based downlink service for data users over the UMTS (Universal Mobile Telecommunications System) with data rates ranging up to several megabits per second.

In an architecture of particular interest to the invention the Radio Network Layer protocols such as RLC (Radio Link Control) and MAC (Medium Access Control), and Transport Network Layer protocols such as AAL2 (ATM Adaptation Layer type 2) and ATM (Asynchronous Transfer Mode), can be located in separate units: e.g., the RLC and MAC in a DMPG (DSP and Macro-diversity Processor Group) units and a AAL2 multiplexer in an A2SU (AAL2 Switching Unit). There are several DMPG units within one RNC which results in situations when the HSDPA connections (MAC-d (MAC-data) flows) going to the same BTS (Base Station) are handled by separate DMPGs.

The RLC and MAC-d layers are of special interest when HSDPA service is implemented. Each HSDPA connection is handled by a separate RLC AM (RLC Acknowledged Mode) entity and a MAC-d entity. The RLC AM entity provides in-sequence and error free delivery of the user data. The latter can be designed in order to handle the air interface errors. This implies that the RLC entity is actively issuing so-called “polls” to a peering entity located in the mobile terminal (in the UE). The mobile terminal responds with Status messages that contain acknowledgements only for the received PDUs (Packet Data Units). In this way the RLC entity is able to decide which PDU should be retransmitted. In HSDPA the retransmissions due to air interface errors are handled by the BTS in order to reduce the L2 RTT (Round Trip Time). Although retransmissions are handled by the BTS, the RLC AM functionality may still reside in the system partly in order to be compatible with earlier (Rel'99) network solutions. This functionality (in ideal conditions) becomes active in the RLC when the maximum number of retransmissions have been reached in the BTS, thereby triggering the retransmission of erroneous PDUs to “fall back” to the RLC. However, the RLC AM entity is not able to distinguish between negative acknowledgements caused by air interface errors and negative acknowledgements caused by congestion and packet drop on the transport network. In order to achieve efficient use of the transport resources, packet drops at the transport should be eliminated. The scope of the internal flow control is to make sure that there are no packet drops on the transport and in the same time the transport resources are used in optimal way.

There is a separate MAC-d entity for each connection in the DMPG and the mobile terminal. The MAC-d schedules the RLC-PDUs (in case of HSDPA connections) based on scheduling information received via the FP: HS-DSCH CAPACITY ALLOCATION (FP=Frame Protocol, HS-DSCH=High-speed Dedicated Shared Channel) control message (HS-DSCH Credits, Interval and Repetition Period). This scheduling is modulated by the flow control messages received from the internal AAL2 flow control. The FP located below the MAC-d layer creates frames out of the scheduled MAC-d PDUs and sends these frames to the AAL2 layer.

FIG. 1 provides an overview of the Iub transport protocols (AAL2 and ATM). The Iu (interface) is defined as a connection point between an RNC or a BSC (Base Station Controller) and a 3G core network. One may classify the user connections towards one BTS 10 as either HSDPA or DCH (Dedicated Channel) connections. One option of the implementation of the HSDPA service of particular interest to this invention is that the traffic generated by the HSDPA users are multiplexed into a CBR (Constant Bit Rate) VCC (Virtual Channel Connection) at the A2SU (AAL2 layer) together with the NRT DCHs (Non Real Time DCH) and RT DCHs (Real Time DCH). In this case there are two priority classes defined in the A2SU, high priority for DCH connections and low priority for the HSDPA connections. When the VCC capacity is limited or the high priority (DCH) traffic intensity increases the low priority buffer can overflow leading to packet drops which affects the QoS (Quality of Service) of the end user. As shown in FIG. 1 the incoming frames to the AAL2 layer are segmented and encapsulated 12 creating in this way the AAL2 CPS-Packets (CPS=Common Part Sublayer) 14. These CPS-Packets are transferred into a high priority buffer 16 (DCH connections) or into a low priority buffer 18 (MAC-d flows). The illustrated buffers 16 and 18 are defined as finite buffers with tail drop, and the scheduling discipline is Strict Priority Scheduling (SPS) with head of line blocking. The CPS-Packets are multiplexed into ATM cells 20 at the RNC 5 and sent over the CBR VCC 22. A Timer CU value is set to zero.

If the flow control feature is active in the RNC 5, the throughput of both buffers 16, 18 is measured and at the same time the queue size of the low priority buffer 18 is sampled periodically. Based on these measurements flow control (FC) messages are sent back to the MAC layer (shown as the arrow A in FIG. 1).

At the receiver (BTS 10) the CPS-Packets are de-multiplexed 24; and the AAL2-SDUs (SDU=Service Data Units) are reassembled 26 and delivered to the FP layer.

The HSDPA flow control entity located in the BTS 10 is also of importance when regarding the performance of the transport network. The flow-control allocates capacity (credits) to the MAC-d flows via the FP: HS-DSCH CAPACITY ALLOCATION control message upon reception of FP: HS-DSCH CAPACITY REQUEST message received from the RNC. The allocation of credits is based on the measured throughput over the air and the queue length of the MAC-d flow in the BTS. This means that the HSDPA flow control is not aware of the available bandwidth for the HSDPA connections.

A problem that arises relates to efficient use of the Iub transport network when HSDPA service is provided.

The MAC-d flows are scheduled by the MAC layer (each MAC-d flow is handled by a MAC-d entity) based on the credits granted by the HSDPA flow control. Over one scheduling interval the number of transferred MAC-d PDUs is upper limited by the amount of available credits. Credits are granted for each MAC-d flow by the HSDPA flow control agent located in the BTS 10 based on the measured throughput over the air interface and the buffer state in the BTS 10. This implies that the HSDPA flow control does not consider the Iub capacity and the bandwidth available for the HSDPA, and it therefore may allocate a higher HSDPA rate than is available in the Iub. When the internal flow control is not activated in the system this over-allocation eventually causes low priority AAL2 buffer 18 overflows and AAL2 packets to be dropped. This condition then triggers RLC retransmissions leading to the deterioration of the end user's QoS (increased RTT, etc.) as the RLC AM entity was designed to handle errors on the air interface. In addition, having a highly loaded AAL2 low priority buffer 18 can result in increased delays in the transport layer, eventually triggering the transition of the RLC AM entity into a Discard or Reset state due to timer expiry.

### SUMMARY

In accordance with one embodiment of the invention is a method, of which the elements include collecting flow statistics for a buffer, determining an available bandwidth for an interface coupled to an output side of the buffer, and determining, from the collected flow statistics and the determined available bandwidth, an arrival rate such that the buffer would not be overloaded. Further in the method is sent a flow control message to each of a plurality of entities that send data to be stored in the buffer. The flow control messages limit aggregate flow from the plurality of entities so as not to exceed the arrival rate.

In accordance with another embodiment of the invention is a program of machine-readable instructions, tangibly embodied on a computer readable memory and executable by a digital data processor, to perform actions directed toward controlling flow to a buffer. In this aspect, the actions include collecting flow statistics for a buffer, determining an available bandwidth for an interface coupled to an output side of the buffer, and from the collected flow statistics and the determined available bandwidth, determining an arrival rate such that the buffer would not be overloaded. Further actions include sending a flow control message, to each of a plurality of entities sending data to be stored in the buffer, that limits aggregate flow from the plurality of entities so as not to exceed the arrival rate.

In accordance with another embodiment of the invention is an apparatus that includes a buffer, a processor, a memory, and a transmitter. The buffer has an input and an output coupled to an interface. The processor is coupled to the memory and executes computer instructions stored on the memory such that it collects flow statistics for the buffer, determines an available bandwidth for the interface, and from the collected flow statistics and the available bandwidth, determines an arrival rate such that the buffer would not be overloaded. The transmitter is adapted to send a flow control message, to each of a plurality of entities sending data to be stored in the buffer, that limits aggregate flow from the plurality of entities so as not to exceed the arrival rate.

In accordance with another embodiment of the invention is an apparatus that includes means for temporarily storing data received from a plurality of entities (in an embodiment, a buffer). This apparatus further includes means for collecting flow statistics for the means for temporarily storing, means for determining an available bandwidth for an interface that is coupled to an output side of the means for temporarily storing, and means for determining from the collected flow statistics and the available bandwidth an arrival rate such that the means for temporarily storing would not be overloaded. In an embodiment, these previous means are embodied in a processor coupled to a memory. Further, the apparatus includes sending means for sending to each of the plurality of entities a flow control message that limits aggregate flow from the plurality of entities so as not to exceed the arrival rate. In an embodiment, the means for sending includes a modem (modulator/demodulator).

In accordance with yet another embodiment of the invention is a method that includes receiving a flow control message, and determining from the received flow control message an allowed amount CR_{allowed} of packet data units PDUs for a scheduling interval I. Further in the method, an allocation of granted credits CR for the scheduling interval I is received, and a send rate sr is computed based on the lower of the allowed amount CR_{allowed} and the granted credits CR. During the scheduling interval, the method continues with sending packet data at a rate not to exceed the send rate sr.

In accordance with yet another embodiment of the invention is an apparatus that includes a receiver, a processor, a memory, and a transmitter. The receiver is adapted to receive a flow control message and an allocation of granted credits CR for a scheduling interval I. The processor is coupled to the receiver and to the memory, and is adapted to determine from the flow control message an allowed amount CR_{allowed} of packet data units PDUs for the scheduling interval I, and to compute a send rate sr based on the lower of the allowed amount CR_{allowed} and the granted credits CR. The transmitter is adapted to transmit packet data during the scheduling interval at a rate not to exceed the send rate sr.

These and other valuable embodiments of the invention are further detailed below.

### BRIEF DESCRIPTION OF THE DRAWINGS

In the attached Drawing Figures:

FIG. 1 illustrates an overview of Iub transport with the AAL2 and ATM layer;

FIG. 2 shows an internal AAL2 flow control architecture in accordance with exemplary embodiments of this invention;

FIG. 3A depicts a first flow control histogram for the AAL2 architecture of FIG. 2 that uses calculated scaling factors;

FIG. 3B depicts a second flow control histogram for the AAL2 architecture of FIG. 2 that uses fixed scaling factors;

FIG. 4 shows a Table defining CPS-Packet sizes; and

FIG. 5 shows a simplified block diagram of various electronic devices that are suitable for use in practicing the exemplary embodiments of this invention.

### DETAILED DESCRIPTION

In order to prevent packet drop and to increase the transport network performance an internal flow control between AAL2 and MAC layers is provided, in particular a flow control algorithm that may be implemented in the RNC.

The use of the exemplary embodiments of this invention enables efficient use of the Iub transport network when HSDPA service is provided, and also facilitates network operation for network operators by adapting the amount of data transferred to the transport layer to the available resources, thereby achieving high network usage without causing packet drops on the transport. These benefits are provided by the flow control mechanism described in detail below.

The exemplary embodiments of this invention provide a dynamic flow control mechanism between AAL2 (ATM Adaptation Layer type 2) and MAC (Medium Access Control) protocol layers within the RNC that enables efficient use of the Iub transport resources, and in the same time prevents packet loss and high delay on the RNCs AAL2 buffers. This beneficially increases the end users' QoS. In addition, the improved and enhanced flow control facilitates the operation of the RNC from at least a transport point of view.

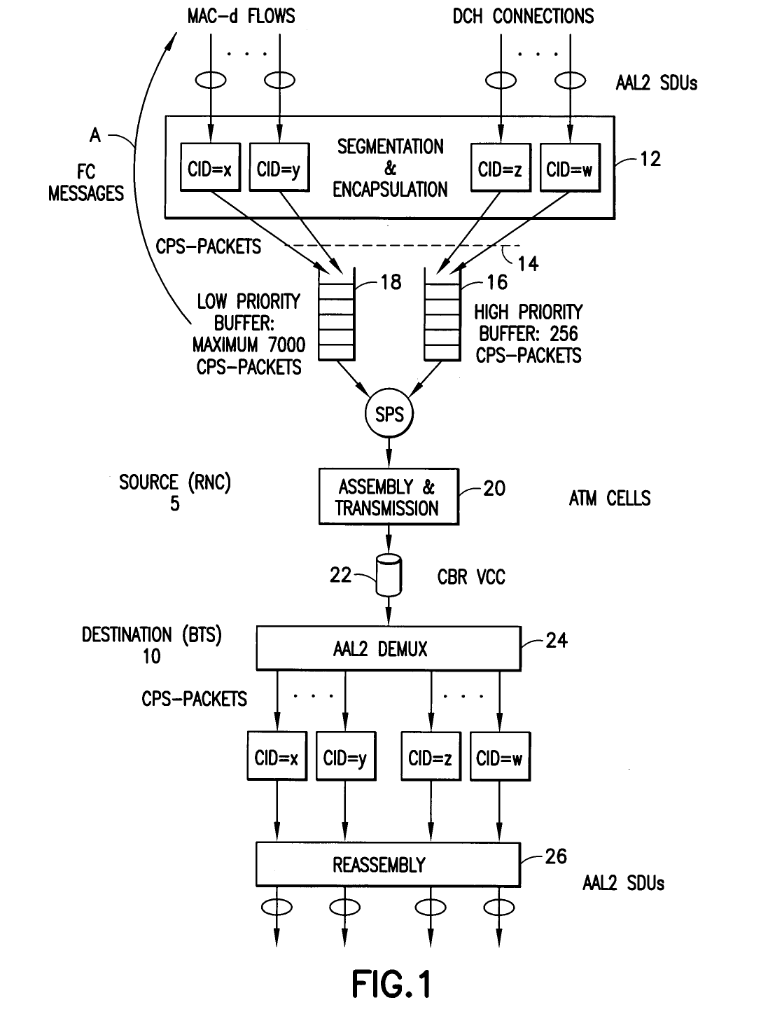

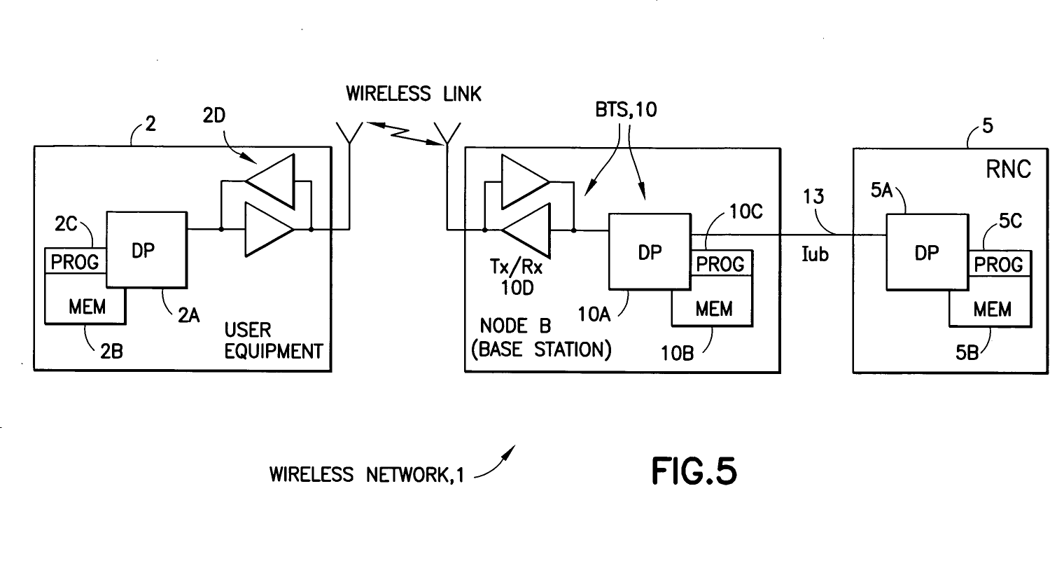

Reference is made first to FIG. 5 for illustrating a simplified block diagram of various electronic devices that are suitable for use in practicing the exemplary embodiments of this invention. In FIG. 5 a wireless network 1 includes a UE 2, a Node B (or base station) that is assumed to include the BTS 10 shown in FIG. 1, and the RNC 5. The UE 2 includes a data processor (DP) 2A, a memory (MEM) 2B that stores a program (PROG) 2C, and a suitable radio frequency (RF) transceiver 2D for bidirectional wireless communications with the BTS 10, which also includes a DP 10A, a MEM 10B that stores a PROG 10C, and a suitable RF transceiver 10D. The BTS 10 is coupled via a data path (the Iub 13) to the RNC 5, which also includes a DP 5A and a MEM 5B storing an associated PROG 5C. At least the PROG 5C is assumed to include program instructions that, when executed by the associated DP 5A, enable the RNC 5 to operate in accordance with the exemplary embodiments of this invention, as will be discussed below in greater detail.

In general, the various embodiments of the UE 2 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable at least by the DP 5A of the RNC 5, or by hardware, or by a combination of software, hardware and firmware.

The MEMs 2B, 5B and 10B may be of any type suitable to the local technical environment and may be implemented using any suitable data storage technology, such as semiconductor-based memory devices, magnetic memory devices and systems, optical memory devices and systems, fixed memory and removable memory. The DPs 2A, 5A and 10A may be of any type suitable to the local technical environment, and may include one or more of general purpose computers, special purpose computers, microprocessors, digital signal processors (DSPs) and processors based on a multi-core processor architecture, as non-limiting examples.

The flow control in accordance with the exemplary embodiments of this invention prevents buffer overflow and long delay times in the AAL2 layer, and also facilitates operating the RNC 5 from at least the transport point of view.

To gain a further appreciation of the exemplary embodiments of this invention, the following points may be noted. First, in conventional operation the MAC-d flows are allocated to the available DMPG units dynamically upon connection setup. Thus, MAC-d flows can be in separate DPMG units making centralized flow control infeasible. Second, the elements of the flow control need to be located at separate protocol layers, and the flow control algorithm should be capable of handling the differences between these layers.

Referring back briefly to FIG. 1, it can be seen that the AAL2 is a layer where packets from various applications are multiplexed into the same ATM cell. In addition, the AAL2 scheduler in the A2SU is a strict priority scheduler in which packets of the HSDPA connections are mapped to the low priority class. However, there are cases when data fragments from low and high priority classes are multiplexed into the same service class. This complicates the estimation of the bandwidth available to the HSDPA service over the Iub 13. In strict priority scheduling the high priority packets are always scheduled first, i.e. low priority packets are only scheduled when the high priority buffer 16 is emptied. This means that there may be intervals when the low priority buffer 18 receives no service, as there is not sufficient bandwidth available for the HSDPA traffic. In other words the bandwidth available for the HSDPA traffic changes over time as a function of the high priority traffic. A known feature of a strict priority buffer is that no delay guarantees can be defined for the low priority traffic. The flow control algorithm in accordance with the exemplary embodiments of this invention is able to accommodate these special problems.

Special requirements related to flow control are that the AAL2 buffer should be kept under steady load, and that low overhead should be maintained by keeping the amount of flow control messages as low as possible. Further, the flow control should offer a high degree of fairness, i.e., it should be able to distribute the available bandwidth in a fair way among the MAC-d flows.

The flow control in accordance with the exemplary embodiments of this invention is implemented to give good performance from at least the following exemplary and non-limiting aspects.

The first aspect is efficiency, i.e., how well the flow control algorithm is able to achieve the operations it has been developed for. Related to efficiency are the following points.

a) The link usage should preferably be close to maximum, i.e., the HSDPA sources should be able to use the total available bandwidth provided that there is data to be sent on the Iub 13 and the HSDPA flow control has not stopped the sources. Link usage is quantified by the packing density and the ATM level throughput.

b) AAL2 multiplexing delays should preferably exceed the maximum delay requirement used by the flow control algorithm with a low probability. This is quantified by the probability of having higher delay than the maximum allowed delay (maximum delay can be exceeded slightly with small probability) and the delay overrun percentage.

c) The amount of flow control messages sent to the users should be as low as possible in order to keep the system under low load. Stated simply, the flow control algorithm should send as few messages as possible.

The second aspect is stability of the flow control, which means that the system should stay in steady state most of the time, i.e., it should not oscillate between flow control states, and the queue length should have small coefficient of variation. Also, it should be able to maintain the low priority buffer 18 loaded so that HSDPA packets are available for transmission whenever the server (scheduler) is not busy with the high priority buffer 16. This is quantified by the percentage of time spent in steady state, i.e., when the overload factor=1.

A third aspect, TCP (Transmission Control Protocol), RLC friendliness, defines how the flow control algorithm interacts with these protocols. Relatedly, no TCP timeouts should be caused by the flow control and the impact on the TCP level throughput should be minimal. That is, TCP sessions should not be halted by the flow control and the TCP throughput should be as high as possible. Further, impact on the RLC AM entity behavior would preferably result in no RLC discards caused by flow control.

A fourth aspect, algorithm fairness, refers to a capability to distribute the available bandwidth among the HSDP connections in a fair way.

While there may be several flow control algorithms known from the literature, none of these algorithms are known to solve the special problem of having flow control between MAC and AAL2 layers, and providing priority scheduling at the AAL2 multiplexer with low priority service for HSDPA traffic.

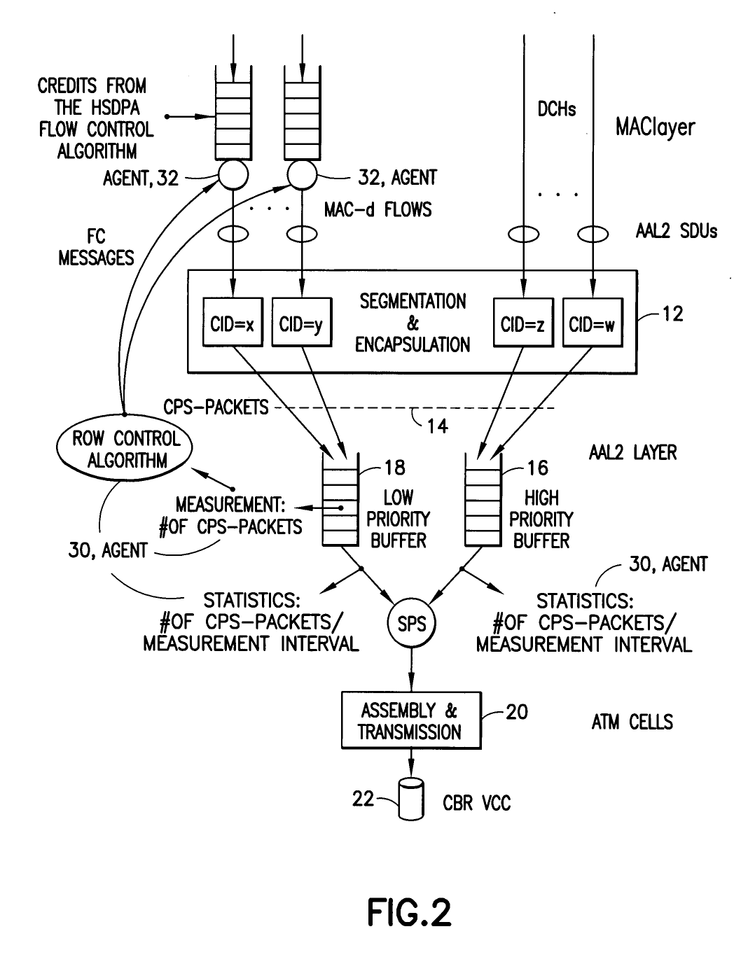

Referring to FIG. 2, the internal flow control architecture in accordance with the exemplary embodiments of this invention includes two types of agents: one agent 30 located at the AAL2 multiplexer in the A2SU and at least one agent 32 located in the DMPGs that are handling the MAC-d flows (HSDPA connections). The former agent 30 collects statistics (at least throughput and queue length), and estimates the required arrival rate to the low priority buffer 18 so that the buffer is not overloaded. The agent 30 also sends flow control messages to the MAC-d entities handling the MAC-d flows (DMPGs), where these flow control messages contain a parameter referred to herein as a scaling factor. The latter agent 32 calculates, based on received flow control messages, the amount of MAC-d PDUs (Packet Data Units) that one MAC-d flow is allowed to send over one HSDPA interval.

The flow control has five simple external parameters on which it can operate:

a) Maximum allowed delay [ms] on the AAL2 multiplexer located in the RNC 5. This is only a soft delay bound meaning that it can be exceeded with small probability.

b) Latency [ms], which is the time between issuing a flow control command and the time point when this command can be considered by the MAC-d layer.

c) Sampling Interval [ms], which is the period during which statistics are collected and the queue length on the low priority buffer 18 in the AAL2 multiplexer is sampled.

d) Increase Rate Timer [ms], which is used to keep alive the MAC-d flows.

e) Size of the low priority AAL2 buffer 18 [CPS-Packets], where the maximum size is, as a non-limiting example, 7000.

In addition to defining how the flow control agents operate, the flow control algorithm has several additional elements that merit consideration, as follows.

A) There are four thresholds defined for the low priority buffer 18. The queue length in the low priority AAL2 buffer 18 is compared against these thresholds and the flow control decision is made based on this comparison. The thresholds are recalculated periodically (with the sampling interval) as a function of the estimated available bandwidth for the HSDPA connections. The available bandwidth can change as a function of the load generated by the high priority connections.

B) The flow control estimates the available bandwidth for HSDPA based on the measured throughput for both the high and low priority buffers 16 and 18.

C) Based on the queue length in the low priority AAL2 buffer 18, and the estimated available bandwidth, the flow control algorithm calculates the required arrival rate and sends a flow control message when a threshold crossing is detected. One particular AAL2 processor used in the A2SU is able to provide only measurements on throughputs and queue length. This information is sufficient only to estimate the total amount of data that arrives at the AAL2 layer during the measurement interval, and is not able to estimate the amount of data one particular MAC-d flow has sent during the measurement interval. Therefore, a flow control message is sent to each MAC-d flow with the same flow control command, with the scaling factor parameter that is a relative measure taking values between zero and one and calculated based on the estimated available bandwidth and arrival rate to the low priority buffer.

The details of the operation of the flow control algorithm are provided below. Note that the flow control is preferably used and implemented in the RNC 5 in those cases where the HSDPA service is supported by the system.

Still referring to FIG. 2, the internal flow control is based on statistics collected at the exit of the AAL2 buffers 16 and 18 (number of transferred CPS-Packets over the measurement interval), and the periodical sampling of the low priority buffer 18 (agent 30). The sampling and measurement intervals can be equal, with a 10 ms default value. The flow control algorithm sends a flow control message (containing the scaling factor parameter) to each MAC-d flow if a threshold (there are, e.g., four thresholds) crossing is detected and recalculates the thresholds. The maximum value of the scaling factor is one; the minimum is 0.1 except for a case where the flow control sends a full stop message with scaling factor=0. Thresholds are recalculated at the end of each measurement interval, based on the measured data. The amount of flow control messages sent at one instance is equal to the number of MAC-d flows (HSDPA connections) in the VCC. As was discussed earlier, the MAC-d flows can be handled by separate DMPGs, and in an extreme case each MAC-d flow is handled in a separate DMPG. The flow control can be optimized such that if more than one MAC-d flow is handled by a DMPG, only one flow control message is sent and this is distributed internally in the DMPG. In this way the overhead generated by the flow control messages can be decreased. In an ideal case each MAC-d flow is handled by the same DMPG and only one flow control message is sent at one instance.

The MAC-d entity (embodied in agent 32) that is handling one individual MAC-d flow calculates the amount of PDUs (CR_{scheduled}) to be scheduled over the HSDPA scheduling interval I (I=10 ms) based on the received flow control command and the credits (CR) granted by the HSDPA flow control algorithm:

CR_{scheduled}=min(CR,CR_{allowed}),

where CR_{allowed} is the amount of MAC-d PDUs calculated based on the flow control command.

The send rate (sr) of the MAC-d flow in this case is:

$$sr = \frac{{CR}_{scheduled}}{I} .$$

In accordance with one embodiment of this invention, in a case where the low priority AAL2 buffer 18 load is light (buffer load decreases below the lowest threshold) a timer (Increase Rate Timer) is started and after its expiry an “Increase Send Rate” message is sent. The scaling factor in this case is two times the one sent previously unless it reaches 1. “Increase Send Rate” message is sent periodically after each expiry of the timer, maximum three times consecutively. The default value of the timer is 100 ms.

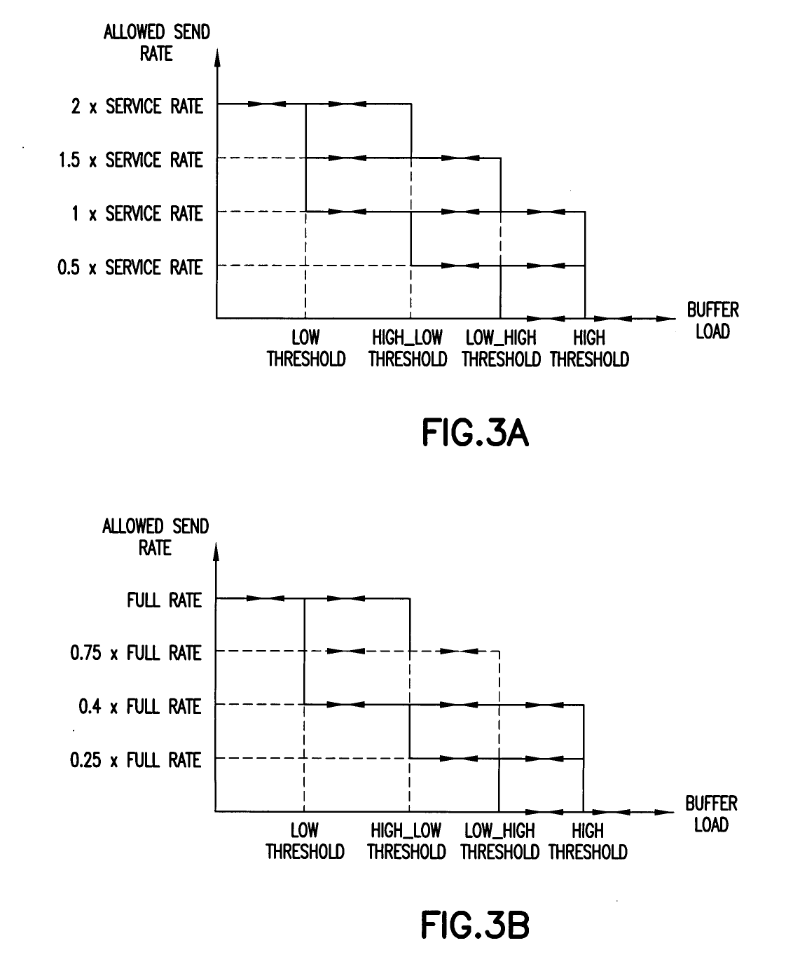

At each sampling interval (at each 10 ms) the queue length in the low priority buffer 18 is sampled. Based on this sample and the estimated available bandwidth for HSDPA (service_rate) the flow control is calculating the allowed_send_rate. The flow control algorithm is described below, and the histogram of the algorithm is shown in FIG. 3A.
A. If Queue≧High threshold: Allowed_send_rate=0
B. If Queue≦Low threshold: Allowed_send_rate=2×service_rate
C. If Queue is growing
   If Queue≧High_Low: Allowed_send_rate=1.5×service_rate
   If Queue≧Low_High: Allowed_send_rate=1×service_rate
D. If queue is decreasing
   If Queue≦Low_High: Allowed_send_rate=0.5×service_rate
   If Queue≦High_Low: Allowed_send_rate=1×service_rate

The values 0, 0.5, 1, 1.5 and 2 are the values the Target Overload (TO) can take. Note that the same threshold crossing cannot be detected several times, one after the other, without first detecting crossing of another threshold.

In accordance with a second embodiment of this invention, and as in the first embodiment, at each sampling interval (at each 10 ms) the queue length in the low priority buffer 18 is sampled. Based on this sample and the estimated available bandwidth for HSDPA (service_rate) the flow control algorithm calculates the allowed_send_rate. The flow control algorithm is described below; the histogram of the algorithm is shown in FIG. 3B.
A. If Queue≧High threshold: Allowed_send_rate=0×Available_credits/Interval
B. If Queue≦Low threshold: Allowed_send_rate=1×Available_credits/Interval
C. If Queue is growing
   If Queue≧High_Low: Allowed_send_rate=0.75×Available_credits/Interval
   If Queue≧Low_High: Allowed_send_rate=0.4×Available_credits/Interval
D. If queue is decreasing
   If Queue≦Low_High: Allowed_send_rate=0.25×Available_credits/Interval
   If Queue≦High_Low: Allowed_send_rate=0.4×Available_credits/Interval

The values 0, 0.25, 0.4, 0.75, 1 are in this embodiment predefined (fixed) scaling factors. Note again that the same threshold crossing cannot be detected several times, one after the other, without first detecting crossing of another threshold.

The thresholds are calculated based on the latency (L), sampling interval (T, with default T=10 ms), arrival rate (Aₙ), estimated service rate (Sₙ), maximum allowed delay on the low priority AAL2 buffer (D) and VCC capacity (C). Out of these parameters the latency, the sampling period and the maximum allowed delay on the low priority AAL2 buffer 18 are external parameters defined when the flow control feature is configured, while the remainder are calculated by the flow control based on the statistics collected.

The latency is defined as the maximum time spent from the time when the flow control message is sent and the time when it the MAC-d scheduler is able to consider this message. This parameter may be defined based on test measurements.

Arrival rate calculation. At the end of each sampling interval, the following AAL2 low and high priority buffer related measurements are available (these are the measurements the AAL2 processor is able to provide):
1. The size of the low priority queue after interval n in CPS-Packets: bₙ
2. The amount of transferred CPS-Packets during interval n from the low priority buffer 18:sₙ
3. The amount of transferred CPS-Packets during interval n from the high priority buffer 16:s^{rt} ₙ

The amount of arrived CPS-Packets during the sampling interval is calculated as follows:

aₙ=sₙ+(bₙ−bₙ₋₁).

This value divided by the sampling interval length gives the arrival rate during interval n. The value used in the threshold calculation, A_{n,} is calculated with weighted average:

Aₙ=Aₙ₋₁·(1−k)+aₙ·k, k=0.056.

### This parameter is in packets per sampling interval.

Service rate calculation. The service rate is the amount of transferred packets over the sampling interval, s'ₙ:

$${s}_{n}^{′} = \{ \begin{matrix}{s}_{n} , & {b}_{n} > 0 \\ Round ( \frac{1}{48} \cdot ( \frac{47 \cdot C \cdot T}{424} - {s}_{n}^{rt} \cdot 39 ) ) , & {b}_{n} = 0\end{matrix}$$

Note that the VCC capacity is given in bits/s. If the VCC capacity is available in cells/s the following formula is preferred for use:

$${s}_{n}^{′} = \{ \begin{matrix}{s}_{n} , & {b}_{n} > 0 \\ Round ( \frac{1}{48} \cdot ( 47 \cdot C \cdot T - {s}_{n}^{rt} \cdot 39 ) ) , & {b}_{n} = 0\end{matrix}$$

The value used in the threshold calculation, Sₙ, is calculated with weighted average:

Sₙ=Sₙ₋₁·(1−k)+sₙ₋₁·k, k=0.056.

Threshold calculation. First, the High threshold T_{H} is calculated:

$${T}_{H} = max ( \frac{1}{T} \cdot ( D \cdot {S}_{n} - max ( 0 , ( {A}_{n} - {S}_{n} ) \cdot ( L + T ) ) ) , \\ 3 \cdot ⌈ ( \frac{L}{T} + 1 ) \cdot {S}_{n} ⌉ + ⌈ \frac{L}{T} \cdot {S}_{n} ⌉ ) .$$

### As the formula above shows, there is a minimum value defined for the High threshold.

### This formula aids in reducing the required number of flow control messages.

The Low_High threshold T_{L}_{_{—}}_{H} is calculated using the already calculated High threshold:

$${T}_{L\_H} = max ( 0.75 \cdot {T}_{H} , 2 \cdot ⌈ ( \frac{L}{T} + 1 ) \cdot {S}_{n} ⌉ + ⌈ \frac{L}{T} \cdot {S}_{n} ⌉ ) .$$

### The second argument in the formula is used in order to keep the relative distance between thresholds at reasonable level.

In similar way the High_Low (T_{H}_{_{—}}_{L}) and Low (T_{L}) thresholds are calculated:

$${T}_{H\_L} = max ( 0.5 \cdot {T}_{H} , ⌈ ( \frac{L}{T} + 1 ) \cdot {S}_{n} ⌉ + ⌈ \frac{L}{T} \cdot {S}_{n} ⌉ ) , \\ {T}_{L} = max ( 0.25 \cdot {T}_{H} , ⌈ \frac{L}{T} \cdot {S}_{n} ⌉ ) .$$

To avoid CPS-Packet drop and to keep the calculated High threshold value below the low priority AAL2 buffer size [CPS-Packets] (B) the following is checked:

T_{H}>B−max(0,(Aₙ−Sₙ)·(L+T)).

If the condition is true, the thresholds are recalculated in the following way:

T_{H}=B−max(0,(Aₙ−Sₙ)·(L+T))

T_{L}_{_{—}}_{H}=0.75·T_{H}

T_{H}_{_{—}}_{L}=0.5·T_{H}

T_{L}=0.25·T_{H}

It should be noted that the size of the low priority buffer 18 should be increased with the VCC capacity, i.e., larger buffer sizes are appropriate when the VCC capacity is increased. Currently, the maximum low priority AAL2 buffer size is 7000 CPS-Packets. One option when the flow control feature is implemented is that the A2SU is configured so that the maximum possible buffer size is allocated for the low priority AAL2 buffer 18.

A special case is when the calculated threshold values are unreasonably low. This can occur when the estimated service rate is temporary low. The following exemplary defaults may then be employed:

T_{H}=80

T_{L}_{_{—}}_{H}=60

T_{H}_{_{—}}_{L}=40

T_{L}=20

Scaling factor calculation. Scaling factor is the parameter sent to the MAC-d layer by the flow control algorithm in the flow control message. It is used to calculate the send rate of the MAC-d flows.

In accordance with the first embodiment discussed above with regard to FIG. 3A, when the buffer is not emptied during the measurement interval the measured throughput (S) is in fact the available service for the HSDPA traffic.

The scaling factor (sf) is calculated based on the Target Overload (TO), estimated bandwidth (Sₙ′), arrival rate (Aₙ′) and previous scaling factor. The different notation is introduced to emphasize that the bandwidth and arrival rates are estimated in different ways when the scaling factor is calculated as compared to the threshold calculations. Target Overload may take the following predefined values: 0, 0.5, 1, 1.5 and 2 based on the queue length relative to the thresholds.

Service rate calculation for scaling factor:

$${S}_{n}^{′} = \frac{{s}_{n - 1}^{′} + {s}_{n}^{′}}{2}$$

Arrival rate calculation for scaling factor:

$${A}_{n}^{′} = \frac{{a}_{n - 1} + {a}_{n}}{2}$$

With these parameters, the scaling factor can be calculated:

$${sf}_{new} = TO \cdot \frac{{S}_{n}^{′}}{{A}_{n}^{′}} \cdot {sf}_{old}$$

The manner in which the scaling factor is calculated has been defined after performing extensive simulations, and may differ in some embodiments from what has been shown. Special cases related the calculation of the scaling factor that should be handled include a case of no arrival (Aₙ′=0), and a case where the previous scaling factor was zero (sf_{old}=0).

The no arrival case can be caused by one or more of the following conditions being true:
the flow control has sent sf=0 earlier to the MAC-d flows;
the MAC-d flows have been stopped by the HSDPA flow control, i.e., they have received zero credits;
there is no data waiting for transmission; and
a measurement error.

Note that the flow control is not aware of the cause of a no arrival occurrence (except the case when sf=0 was sent) and it is not able to calculate the sf with the basic formula. In the cases when Aₙ′=0 and (or) Sf_{old}=0, the last valid, non-zero Aₙ and sf_{old} are used to calculate the sf_{new}. Additionally, when the queue decreases below the Low threshold and there is no arrival, the scaling factor is set to one, i.e., the flow control algorithm is “turned off”. In this way the generation of unnecessary increase rate messages is avoided.

In accordance with the second embodiment discussed above with regard to FIG. 3B, the scaling factor (sf) is selected based on the queue length relative to the thresholds, as is shown in FIG. 3B.

Calculation of the send rate at the MAC layer. The flow control messages are sent to each MAC-d flow individually. Each MAC-d entity calculates the amount of MAC-PDUs transferred over one HSDPA interval by multiplying the scaling factor and the available credits (granted by the HSDPA flow control). As the MAC-d flow is able to send zero, one, two, etc. MAC-d PDUs, the case when the calculated send rate is below 1 MAC-d PDU over the HSDPA interval is handled by sending one MAC-d PDU. The minimum value of the scaling factor sent to the MAC-d flows is set to 0.1 (except when it is explicitly zero), in accordance with the first embodiment of the invention discussed in relation to FIG. 3A. For the case of the second embodiment discussed above with regard to FIG. 3B, as the MAC-d flow is able to send zero, one, two, etc. MAC-d PDUs, the case when the calculated send rate is below 1 MAC-d PDU over the HSDPA interval is handled by sending one MAC-d PDU (only if the scaling factor was not zero).

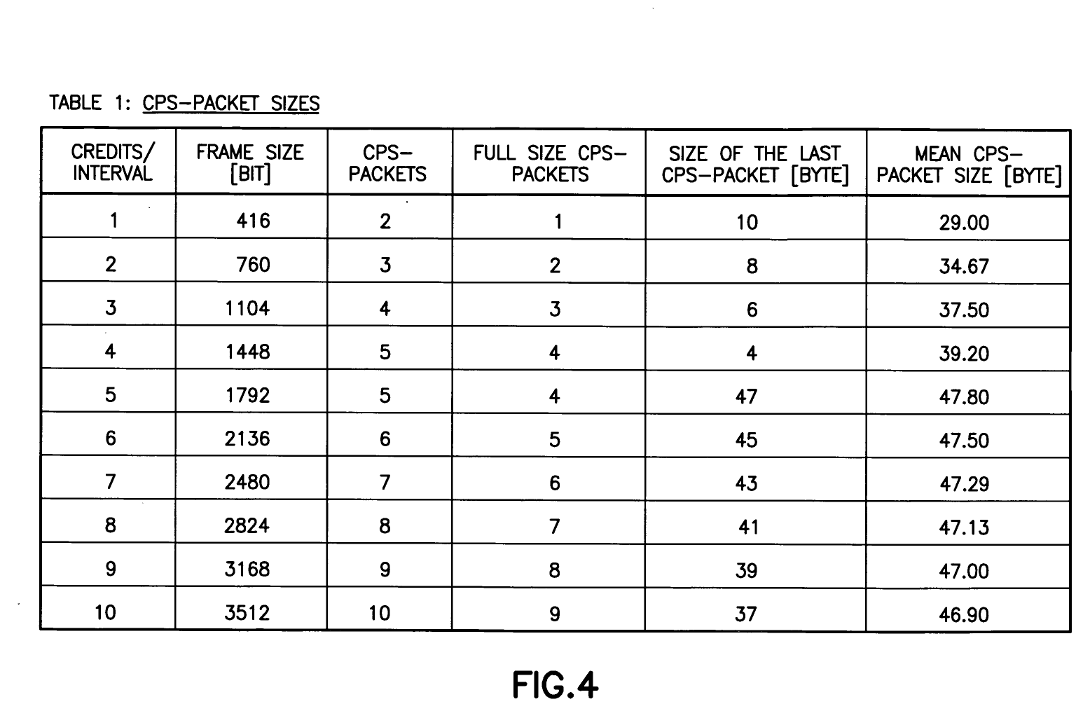

At low bandwidth an occurrence of low rate conversion errors (between an arrival rate expected at the AAL2 layer and the MAC-d PDUs sent by the MAC-d layer) can affect the system performance. Therefore, it is preferred that the conversions listed in Table 1 and shown in FIG. 4 be used. Table 1 shows the number and size of the CPS-Packets as a function of the HS-DSCH FP frame size, which depends on the number of allocated credits (the table contains data only up to ten credits, which is not a limitation on the use of this invention). The assumption is that there are a sufficient number of PDUs waiting for transmission in the MAC layer. The control frames are not shown.

In accordance with the first embodiment of the invention discussed in relation to FIG. 3A, the scaling factor is calculated using the measured throughput in CPS-Packets. As the scaling factor is calculated at the AAL2 layer, and it refers to the expected arrival rate in CPS-Packets, the amount of MAC-d PDUs should be calculated accordingly, at the MAC-d layer (provided that there are enough credits granted by the HSDPA flow control algorithm).

In accordance with the second embodiment of the invention discussed in relation to FIG. 3B, the scaling factor is selected based on the queue length relative to the thresholds. As the scaling factor is in this second embodiment selected at the AAL2 layer, and refers to the expected arrival rate in CPS-Packets, the amount of MAC-d PDUs should be calculated accordingly at the MAC-d layer (again provided that there are enough credits granted by the HSDPA flow control algorithm).

In either case (embodiment one (FIG. 3A) or embodiment two (FIG. 3B)) the amount of MAC-d PDUs to be scheduled at the HSDPA interval is calculated based on the received scaling factor and the conversion tables stored at the MAC-d layer. In the calculation the amount of credits granted by the HSDPA flow control is also considered.

First, the available credits (CR) i.e. the number of MAC-d PDUs allowed by the HSDPA flow control are converted into their equivalent number of AAL2 CPS-Packets (N_{equivalent}). For this operation the first and third columns of Table 1 are used.

The number of AAL2 CPS-Packets (N_{allowed}) allowed by the internal flow control is calculated with the following formula:

N_{allowed}=rounds(sf·N_{equivalent}).

### This is converted back to MAC-d PDUs to be scheduled (CR_{allowed}) using the third and the first column of Table 1.

Next, the maximum amount of MAC-d PDUs that can be scheduled (CR_{scheduled}) over the HSDPA interval is calculated with the formula:

CR_{Scheduled}=Min(CR,CR_{allowed}).

### Of course, the MAC-d layer is able to schedule this number of PDUs only if there are a sufficient number of PDUs waiting for transmission.

A number of advantages are realized by the use of the exemplary embodiments of this invention. As non-limiting examples, the use of the exemplary embodiments of this invention provides a dynamic flow control mechanism between the AAL2 (ATM Adaptation Layer type 2) and MAC (Medium Access Control) protocol layers within the RNC 5 that enables efficient use of the Iub 13 transport resources, and at the same time prevents packet loss and high delay in the RNCs AAL2 buffers 16 and 18. This enables the end user QoS to be enhanced. In addition, the flow control algorithm in accordance with the exemplary embodiments of this invention facilitates the operation of the RNC 5 from at least the transport point of view. The use of the exemplary embodiments of this invention reduces overhead caused by flow control messages, and further enhances robustness in a relatively simple manner.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

We claim:

1. A method comprising:
collecting flow statistics for a buffer;
determining an available bandwidth for an interface coupled to an output side of the buffer;
from the collected flow statistics and the determined available bandwidth, determining an arrival rate such that the buffer would not be overloaded; and
sending a flow control message to each of a plurality of entities sending data to be stored in the buffer that limits aggregate flow from the plurality of entities so as not to exceed the arrival rate.

2. The method of claim 1, wherein the interface comprises a constant bit rate virtual control connection CBR-VCC, the method further comprising:
multiplexing data in the buffer received from multiple ones of the plurality of entities and sending the multiplexed data over the CBR-VCC.

3. The method of claim 1 executed by a radio network controller, wherein the buffer lies within an Asynchronous Transfer Mode Adaptation Layer type 2 AAL2 protocol layer, and the buffer receives the data from the plurality of entities over a medium access control MAC protocol layer.

4. The method of claim 1, wherein collecting flow statistics comprises comparing a queue length of the buffer against a high threshold T_{H} and against a low threshold T_{L}, and wherein sending the flow control message is responsive to the queue length crossing one of the high and low thresholds.

5. The method of claim 4, wherein the thresholds are calculated based on at least two of:
an arrival rate Aₙ of packets in the buffer during a sampling interval T over which the flow statistics are collected,
a service rate Sₙ of packets transferred from the buffer during the sampling period,
a maximum allowed delay D for packets in the buffer,
a latency L between a time the flow control messages are sent and a time the entities are considered to comply with the messages, and
the available bandwidth.

6. The method of claim 5, wherein
$${T}_{H} = max ( \frac{1}{T} \cdot ( D \cdot {S}_{n} - max ( 0 , ( {A}_{n} - {S}_{n} ) \cdot ( L + T ) ) ) , \\ 3 \cdot ⌈ ( \frac{L}{T} + 1 ) \cdot {S}_{n} ⌉ + ⌈ \frac{L}{T} \cdot {S}_{n} ⌉ ) .$$

7. The method of claim 4, further comprising computing the high threshold T_{H} and computing the low threshold T_{L}, and wherein the steps of collecting, determining an available bandwidth, determining an arrival rate, computing the high threshold T_{H}, computing the low threshold T_{L}, and comparing a queue length of the buffer are repeated for each sequential sampling interval T.

8. The method of claim 1, wherein the said buffer comprises a low priority buffer, and wherein determining the available bandwidth comprises:
measuring a throughput for the low priority buffer and for a high priority buffer having an output side coupled to the interface, and
estimating available bandwidth based on the measured throughput of the buffers.

9. The method of claim 1, wherein the flow control messages sent to each of the plurality of entities comprises a scaling factor selected based on a queue length of the buffer relative to a high threshold and to a low threshold.

10. The method of claim 9, wherein the said flow control messages sent to each of the plurality of entities comprise the same scaling factor.

11. A program of machine-readable instructions, tangibly embodied on a computer readable memory and executable by a digital data processor, to perform actions directed toward controlling flow to a buffer, the actions comprising:
collecting flow statistics for a buffer;
determining an available bandwidth for an interface coupled to an output side of the buffer;
from the collected flow statistics and the determined available bandwidth, determining an arrival rate such that the buffer would not be overloaded; and
sending a flow control message to each of a plurality of entities sending data to be stored in the buffer that limits aggregate flow from the plurality of entities so as not to exceed the arrival rate.

12. The program of claim 11, wherein the interface comprises a constant bit rate virtual control connection CBR-VCC, the actions further comprising:
multiplexing data in the buffer received from multiple ones of the plurality of entities and sending the multiplexed data over the CBR-VCC.

13. The program of claim 11, wherein the memory and the processor are disposed in a radio network controller, wherein the buffer lies within an Asynchronous Transfer Mode Adaptation Layer type 2 AAL2 protocol layer, and the buffer receives the data from the plurality of entities over a medium access control MAC protocol layer.

14. The program of claim 11, wherein collecting flow statistics comprises comparing a queue length of the buffer against a high threshold T_{H} and against a low threshold T_{L}, and wherein sending the flow control message is responsive to the queue length crossing one of the high and low thresholds.

15. The program of claim 14, wherein the actions further comprises calculating the high threshold T_{H} as:
$${T}_{H} = max ( \frac{1}{T} \cdot ( D \cdot {S}_{n} - max ( 0 , ( {A}_{n} - {S}_{n} ) \cdot ( L + T ) ) ) , \\ 3 \cdot ⌈ ( \frac{L}{T} + 1 ) \cdot {S}_{n} ⌉ + ⌈ \frac{L}{T} \cdot {S}_{n} ⌉ )$$
wherein: Aₙ is an arrival rate of packets in the buffer during a sampling interval T over which the flow statistics are collected,
Sₙ is a service rate of packets transferred from the buffer during the sampling period,
D is a maximum allowed delay for packets in the buffer, and
L is a latency time between a time the flow control messages are sent and a time the entities are considered to comply with the messages.

16. The program of claim 11, wherein the said buffer comprises a low priority buffer, and wherein determining the available bandwidth comprises:
measuring a throughput for the low priority buffer and for a high priority buffer having an output side coupled to the interface, and
estimating available bandwidth based on the measured throughput of the buffers.

17. The program of claim 11, wherein the flow control messages sent to each of the plurality of entities comprises a scaling factor selected based on a queue length of the buffer relative to a high threshold and to a low threshold.

18. An apparatus comprising:
a buffer having an input and an output coupled to an interface;
a processor coupled to a memory and executing computer instructions stored on the memory adapted to collect flow statistics for the buffer, to determine an available bandwidth for the interface, and to determine from the collected flow statistics and the available bandwidth an arrival rate such that the buffer would not be overloaded; and
a transmitter adapted to send a flow control message to each of a plurality of entities sending data to be stored in the buffer that limits aggregate flow from the plurality of entities so as not to exceed the arrival rate.

19. The apparatus of claim 18, wherein the interface comprises a constant bit rate virtual control connection CBR-VCC, the apparatus further comprising:
a multiplexer coupled between the buffer and the interface for multiplexing data output from the buffer and received from multiple ones of the plurality of entities.

20. The apparatus of claim 18, wherein the apparatus comprises a radio network controller, wherein the buffer lies within an Asynchronous Transfer Mode Adaptation Layer type 2 AAL2 protocol layer, and the buffer receives the data from the plurality of entities over a medium access control MAC protocol layer.

21. The apparatus of claim 18, wherein the processor coupled to the memory adapted to collect flow statistics comprises comparing a queue length of the buffer against a high threshold T_{H} and against a low threshold T_{L}, wherein sending the flow control message is responsive to the queue length crossing one of the high and low thresholds.

22. The apparatus of claim 21, wherein the processor coupled to the memory is adapted to calculate the high threshold T_{H} as:
$${T}_{H} = max ( \frac{1}{T} \cdot ( D \cdot {S}_{n} - max ( 0 , ( {A}_{n} - {S}_{n} ) \cdot ( L + T ) ) ) , \\ 3 \cdot ⌈ ( \frac{L}{T} + 1 ) \cdot {S}_{n} ⌉ + ⌈ \frac{L}{T} \cdot {S}_{n} ⌉ )$$
wherein: Aₙ is an arrival rate of packets in the buffer during a sampling interval T over which the flow statistics are collected,
Sₙ is a service rate of packets transferred from the buffer during the sampling period,
D is a maximum allowed delay for packets in the buffer, and
L is a latency time between a time the flow control messages are sent and a time the entities are considered to comply with the messages.

23. The apparatus of claim 18, wherein the said buffer comprises a low priority buffer, the apparatus further comprising a high priority buffer in parallel with the low priority buffer, and wherein the processor and memory are adapted to determine the available bandwidth by:
measuring a throughput for the low priority buffer and for the high priority buffer, and
estimating available bandwidth based on the measured throughput of the buffers.

24. The apparatus of claim 18, wherein the flow control messages sent to each of the plurality of entities comprises a scaling factor selected based on a queue length of the buffer relative to a high threshold and to a low threshold.

25. An apparatus comprising:
means for temporarily storing data received from a plurality of entities;
means for collecting flow statistics for the means for temporarily storing;
means for determining an available bandwidth for an interface coupled to an output side of the means for temporarily storing;
means for determining from the collected flow statistics and the available bandwidth an arrival rate such that the means for temporarily storing would not be overloaded; and
sending means for sending a flow control message to each of the plurality of entities that limits aggregate flow from the plurality of entities so as not to exceed the arrival rate.

26. The apparatus of claim 25, wherein:
the means for temporarily storing comprises a buffer;
the means for collecting, means for determining flow statistics and means for determining an arrival rate comprise a digital processor coupled to a memory of computer readable instructions; and
the sending means comprises a modem.

27. A method comprising:
receiving a flow control message;
determining from the flow control message an allowed amount CR_{allowed} of packet data units PDUs for a scheduling interval I;
receiving an allocation of granted credits CR for the scheduling interval I;
computing a send rate sr based on the lower of the allowed amount CR_{allowed} and the granted credits CR; and
during the scheduling interval, sending packet data at a rate not to exceed the send rate sr.

28. The method of claim 27 wherein the lower of the allowed amount CR_{allowed} and the granted credits CR is a scheduled amount CR_{scheduled}, and
$$sr = \frac{{CR}_{scheduled}}{I} ,$$
where the scheduling interval I is for a high speed data packet access HSPDA network.

29. The method of claim 28, wherein sending packet data at the send rate sr comprises sending packet data at the send rate sr simultaneously on each of at least two concurrent flows.

30. The method of claim 27, wherein the flow control message comprises a scaling factor, and determining the allowed amount CR_{allowed} comprises multiplying the scaling factor by the granted credits CR.

31. The method of claim 30, wherein determining the allowed amount CR_{allowed} comprises multiplying the scaling factor by the granted credits CR and if non-zero, rounding up.

32. The method of claim 27, wherein sending packet data comprises:
converting a number of granted credits CR to an equivalent number N_{equivalent} of common part sublayer CPS packets;
converting the equivalent number N_{equivalent} to an allowed number N_{allowed} of CPS packets using a scaling factor received in the flow control message; and
converting the allowed number N_{allowed} to the allowed amount CR_{allowed}.

33. The method of claim 27 executed by a mobile station.

34. The method of claim 27 stored as computer instructions on a memory and executed by a digital processor.

35. An apparatus comprising:
a receiver adapted to receive a flow control message and an allocation of granted credits CR for a scheduling interval I;
a processor, coupled to the receiver and to a memory, adapted to determine from the flow control message an allowed amount CR_{allowed} of packet data units PDUs for the scheduling interval I, and to compute a send rate sr based on the lower of the allowed amount CR_{allowed} and the granted credits CR; and
a transmitter adapted to transmit packet data during the scheduling interval at a rate not to exceed the send rate sr.

36. The apparatus of claim 35, wherein the processor attributes the lower of the allowed amount CR_{allowed} and the granted credits CR as a scheduled amount CR_{scheduled}, and
$$sr = \frac{{CR}_{scheduled}}{I} ,$$
where the scheduling interval I is for a high speed data packet access HSPDA network.

37. The apparatus of claim 35, wherein the flow control message comprises a scaling factor, and the processor determines the allowed amount CR_{allowed} by multiplying the scaling factor by the granted credits CR.

38. The apparatus of claim 35, wherein the processor is configured to determine the allowed amount CR_{allowed} of packet data units PDUs for the scheduling interval I by:
converting the allocation of granted credits CR to an equivalent number N_{equivalent} of common part sublayer CPS packets;
converting the equivalent number N_{equivalent} to an allowed number N_{allowed} of CPS packets using a scaling factor received in the flow control message; and
converting the allowed number N_{allowed} to the allowed amount CR_{allowed}.
